(19) United States
(12) Patent Application Publication
(10) Pub. No.: US 2026/0156638 A1
(43) Pub. Date: Jun. 4, 2026

(54) WIRELESS COMMUNICATION DEVICE, METHOD AND SYSTEM

(71) Applicant: MEDIATEK INC., Hsinchu City (TW)

(72) Inventors: Kuo-Wei Chen, Hsinchu City (TW); Chia-Jung Hsu, Hsinchu City (TW); Yi-Lon Chin, Hsinchu City (TW); Chih-Hsing Chang, Hsinchu City (TW); Kun-Sheng Huang, Hsinchu City (TW)

(21) Appl. No.: 18/964,755

(22) Filed: Dec. 2, 2024

(51) Int. Cl. H04W 72/1263; H04W 72/543

(52) U.S. Cl. CPC H04W 72/1263; H04W 72/543

(57) ABSTRACT

The application discloses a wireless communication method and device. A first wireless communication device determines a transmission time boundary for latency sensitive traffic. A traffic transmission request frame from a second wireless communication device is received, wherein the traffic transmission request frame includes a duration information indicating a duration period during which the second wireless communication device expects to occupy a channel. In response to a determination that the duration period exceeds the transmission time boundary and traffic from the second wireless communication device to the first wireless communication device is latency non-sensitive, the first wireless communication device decides not to send a traffic transmission permission frame to the second wireless communication device. The latency sensitive traffic is transmitted from the first wireless communication device to the second wireless communication device or at least one third wireless communication device before the transmission time boundary.

### TECHNICAL FIELD

The disclosure relates to a wireless communication device, method and system.

### BACKGROUND

Institute of Electrical and Electronics Engineers (IEEE) wireless next generation (WNG) standing committee (SC) is a committee within IEEE focused on the development and standardization of next-generation wireless technologies. Ultra High Reliability (UHR) study group (SG) is a study group focused on achieving extremely high reliability in wireless communications. Some proposals in IEEE WNG SC and UHR SG suggest that for next-generation wireless technologies and high-reliability applications, the latency should be very low, in the range of 0.1 to 10 milliseconds. Latency refers to the delay before a transfer of data begins following an instruction for its transfer.

Wi-Fi technology is designed to be compatible with older versions of Wi-Fi standards, meaning new devices can still communicate with older devices. There may be many legacy devices and bi-directional traffic flow in the same network. Legacy devices refer to that the older devices that still use older versions of Wi-Fi standards. Bi-directional traffic flow means data can flow in both directions, both uploading (UL) and downloading (DL), simultaneously in the same Wi-Fi network.

In the prior cases that there exists some latency sensitive traffic, latency requirement (or said, delay bound or delay requirement) of the latency sensitive traffic can't be reached because a channel for transmitting the latency sensitive traffic is occupied by other traffic.

Thus, there needs a wireless communication device, method and system which may resolve prior and other problems to reach latency requirements.

### SUMMARY

According to one embodiment, a wireless communication method is provided. The wireless communication method comprises: determining a transmission time boundary for a transmission by a first wireless communication device; receiving a traffic transmission request frame by the first wireless communication device from a second wireless communication device, wherein the traffic transmission request frame comprises duration information indicating a duration period during which the second wireless communication device expects to occupy a channel; in response that the first wireless communication device determines that the duration period exceeds the transmission time boundary and traffic from the second wireless communication device to the first wireless communication device is latency non-sensitive, deciding by the first wireless communication device not to send a traffic transmission permission frame to the second wireless communication device; and starting the transmission on the channel before the transmission time boundary.

According to another embodiment, a wireless communication device is provided. The wireless communication device comprises: a processor; and a transceiver coupled to the processor. The processor is configured for: determining a transmission time boundary for a transmission; receiving a traffic transmission request frame from a second wireless communication device, wherein the traffic transmission request frame comprises duration information indicating a duration period during which the second wireless communication device expects to occupy a channel; in response that determining that the duration period exceeds the transmission time boundary and traffic from the second wireless communication device is latency non-sensitive, deciding not to send a traffic transmission permission frame to the second wireless communication device; and starting the transmission on the channel before the transmission time boundary.

### BRIEF DESCRIPTION OF THE DRAWINGS

FIG. 1 shows wireless communication according to one embodiment of the application.

FIG. 2 shows setting a transmission time boundary for latency sensitive traffic by the access point in one embodiment of the application.

FIG. 3 shows decision by the access point (AP) about not to respond the clear-to-send (CTS) frame to the station (STA) according to one embodiment of the application.

FIG. 4A and FIG. 4B show that the AP transmits latency sensitive traffic according to one embodiment of the application.

FIG. 5 shows that the AP transmit latency-sensitive traffic directly after receiving RTS frame and waiting through space frames according to one embodiment of the application.

FIG. 6A to FIG. 6C show several example of wireless communication according to one embodiment of the application.

FIG. 7 shows an example of wireless communication according to one embodiment of the application.

FIG. 8 shows a flow chart for a wireless communication method according to one embodiment of the application.

FIG. 9 shows a functional block diagram of a wireless communication device according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

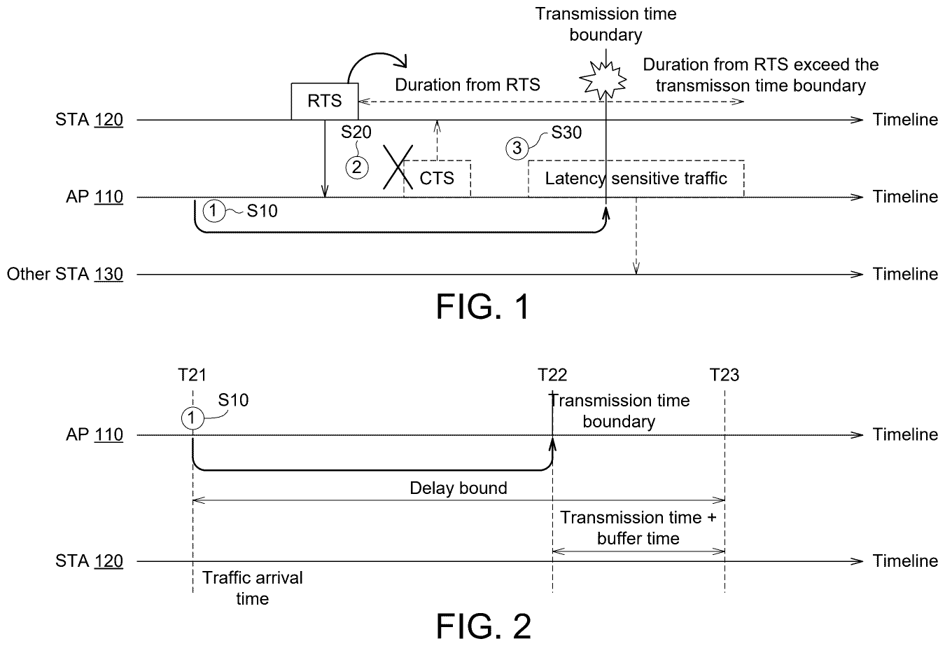

FIG. 1 shows wireless communication according to one embodiment of the application. In FIG. 1, an AP (access point) 110 and two STAs (station) 120 and 130 are both referred as wireless communication devices compatible with Wi-Fi technology.

As shown in FIG. 1, the AP 110 sets a transmission time boundary for DL latency sensitive traffic at step S10. The DL latency sensitive traffic is high priority traffic.

The STA 120 transmits a RTS (request to send) frame (i.e. a traffic transmission request frame) to the AP 110, wherein the RTS frame includes a duration information indicating a duration period during which the STA 120 expects to occupy a channel. If the AP 110 determines that (1) the duration period indicated by the duration information contained in the RTS frame from the STA 120 to the AP 110 exceeds the transmission time boundary for the high priority traffic and (2) a UL (uplink) traffic priority is low priority based on prediction, the AP 110 decides not to respond the CTS (clear to send) frame (i.e. a traffic transmission permission frame) to the STA 120 at step S20. In the following, low priority traffic refers to latency non-sensitive traffic while high priority traffic refers to latency sensitive traffic.

The AP 110 transmits latency sensitive traffic on the channel to the target station(s) at step S30.

In one embodiment of the application, details of the AP 110 setting the transmission time boundary for DL latency sensitive traffic at step S10 are described. Here are two possible scenarios, which are not to limit the application.

In the first transmission time boundary setting scenario, the user defines on the AP 110 about the latency requirements for certain devices based on specific needs, thereby calculating the transmission time boundary for these traffic flows. That is, in the first transmission time boundary setting scenario (where the user defines the latency requirements), the user specifies on the AP 110 about the latency requirements for certain devices. Based on these specified requirements, the AP 110 calculates the transmission time boundary for the traffic flows of these devices. This approach allows for customized settings based on specific needs, ensuring that the devices meet the required latency standards. The latency requirements may comprise at least one of a delay bound, a start time of a latency sensitive traffic service and an interval for transmitting the latency sensitive traffic.

In the second transmission time boundary setting scenario, the AP 110 calculates the transmission time boundary for these traffic flows based on the QoS (Quality of Service) characteristics elements reported by the STAs (120, or 130 or still other stations). In the second transmission time boundary setting scenario, the AP 110 calculates the transmission time boundary based on the QoS characteristics elements reported by the STAs (120, or 130 or still other stations). Usually, QoS characteristics elements comprise at least one element that may describe the quality of service required by the station, such as at least one of the following: a delay bound, a start time of a latency sensitive traffic service, and an interval for transmitting the latency sensitive traffic. The AP 110 uses this information to determine the appropriate transmission time boundary for transmitting the latency-sensitive traffic, ensuring that the traffic meets the required quality of service.

In one embodiment of the application, in both scenarios, the goal is to ensure that latency-sensitive traffic is transmitted at a time that does not exceed the transmission boundary time to meet the required performance requirements. The first transmission time boundary setting scenario relies on user-defined requirements, while the second transmission time boundary setting scenario uses information reported by the STA to the AP.

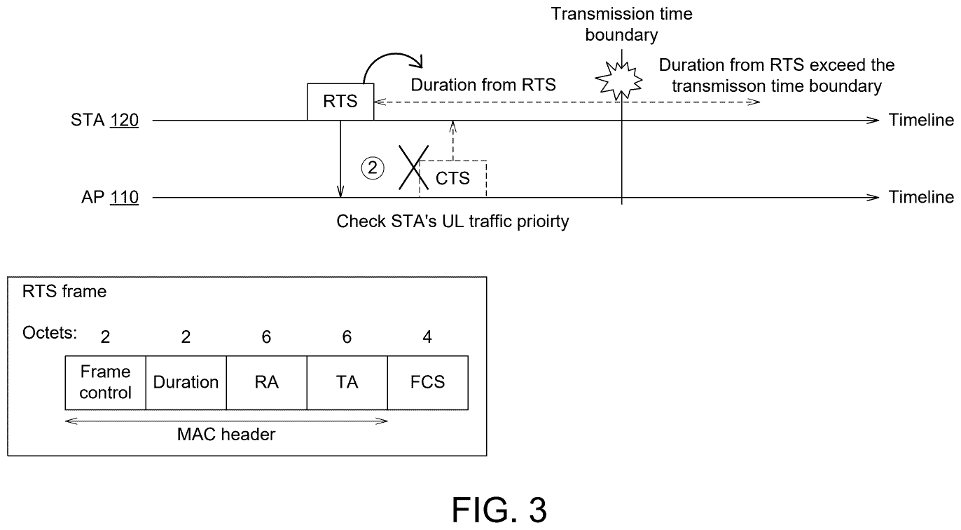

FIG. 2 shows setting a transmission time boundary for DL latency sensitive traffic by the AP in one embodiment of the application. As shown in FIG. 2, at timing T21, the AP receives the latency sensitive traffic and puts the latency sensitive traffic in a queue. That is, the timing T21 is a latency sensitive traffic arrival time.

Timing T22 indicates the transmission time boundary.

Timing T23 indicates a time when the latency sensitive traffic is received by STA(s), wherein the time interval between T1 and T3 is the delay bound.

In one embodiment of the application, the transmission time boundary for different types of latency-sensitive traffic can be determined based on the various information provided below. In the following, two types of latency-sensitive traffic are described in determining the transmission time boundary, i.e. predictable traffic and non-predictable traffic.

For predictable traffic, the AP 110 determines the transmission time boundary based on a predictable traffic arrival time, a delay bound, a transmission time and a buffer time, wherein the transmission time depends on a traffic size and a transmission rate of the predictable traffic, and the buffer time is a value set based on air condition. When the air condition is very congested and collisions are likely to occur easily, a larger buffer time needs t o be set. The predictable traffic arrival time is calculated based on the start time of the latency sensitive traffic service and the interval for transmitting the latency sensitive traffic. For example but not limited by, for predictable traffic, the AP 110 determines the transmission time boundary by the following equation (1A).

Transmission time boundary=predictable traffic arrival time+delay bound (transmission time+buffer time) (1A)

The content of the latency sensitive service is transmitted periodically based on the interval, and the AP 110 periodically receives the latency sensitive traffic. The AP 110 calculates a transmission boundary for each received latency sensitive traffic. The received latency sensitive traffic may comprise one or more frames.

For non-predictable traffic, the AP 110 determines the transmission time boundary based on an actual traffic arrival time, a delay bound, a transmission time and a buffer time of the non-predictable traffic. For example but not limited by, for non-predictable traffic, the AP 110 determines the transmission time boundary by the following equation (1B).

Transmission time boundary=actual traffic arrival time+delay bound (transmission time+buffer time) (1B)

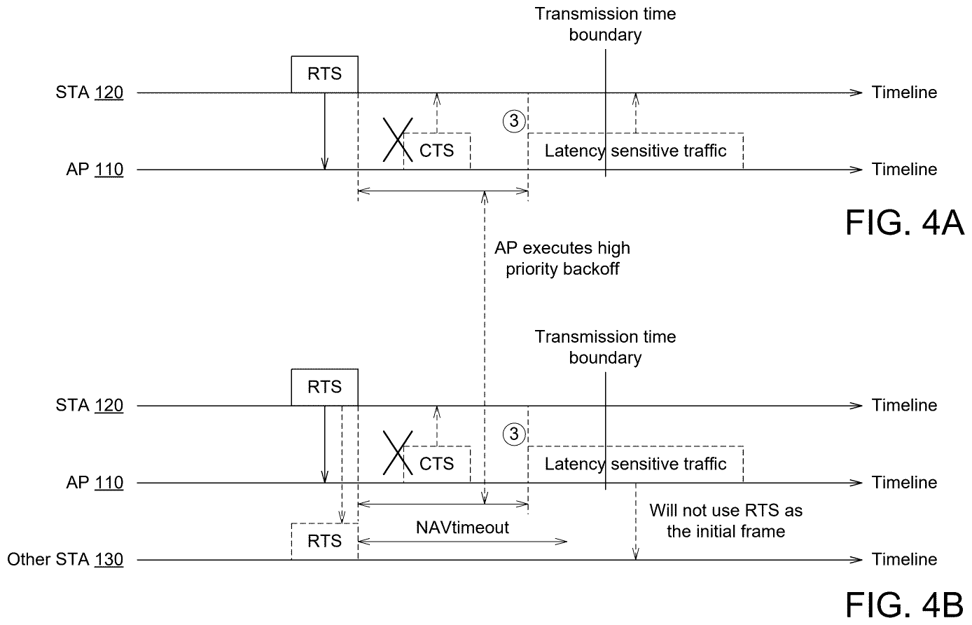

FIG. 3 shows decision by the AP about not to respond the CTS frame to the STA according to one embodiment of the application. As shown in FIG. 3, if the duration period indicated by the duration information contained in the RTS frame from the STA 120 to the AP 110 exceeds the transmission time boundary and the AP 120 checks that the UL traffic priority from the STA 120 is low priority (based on prediction), the AP 120 decides not to respond the CTS frame to the STA 120. If recent UL traffic (in the predetermined periods) from the STA 120 is always low priority traffic, the AP 110 decides that the STA's UL traffic priority is low priority.

FIG. 3 also shows that the RTS frame including a MAC (Media Access Control) header according to one embodiment of the application. The MAC header includes frame control field, duration field, receiving address (RA) field, and transmission address (TA) field. The duration field includes duration information indicating a duration period during which the STA 120 expects to occupy a channel.

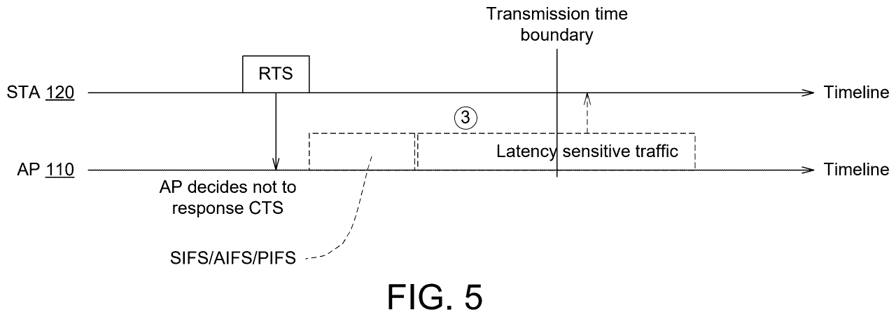

FIG. 4A and FIG. 4B show that the AP transmits latency sensitive traffic according to one embodiment of the application.

When the AP 110 has the latency sensitive traffic that needs to be sent, the AP 110 may perform at least one of the following operations: (1) the AP 110 may execute a high priority backoff procedure after reception of the RTS frame is completed; (2) if the AP 110 wants to transmit latency sensitive traffic to other STA whose a Network Allocation Vector timeout “NAVtimeout” is not expired, the AP 110 will not use the RTS frame as the initial frame (i.e. the AP 110 prevents from using the RTS frame as the initial frame); and (3) in order to increase the chances of success, the AP 110 may transmit the latency-sensitive traffic directly after receiving RTS frame and waiting for Short Interframe Space (SIFS) time, and/or Point coordination function (PCF) Interframe Space (PIFS) time, and/or Arbitration Interframe space (AIFS) time or the like. NAVtimeout may equal to (2* SIFStime)+(CTS_time)+RxPHYStartDelay+(2*Slottime) as defined in 802.11 ax standard.

In one embodiment of the application, high priority backoff procedure executed by the AP 110 refers to that the AP 110 performs a backoff procedure based on some backoff parameters corresponding to the AC (access category) of the traffic that needs to be transmitted, wherein the AC of the traffic is a high priority AC, for example, AC_VO or AC_VI. The backoff parameters may include AIFSN (Arbitration Inter Frame Spacing Number), CWmin (Minimum Contention Window) and CWmax (Maximum Contention Windows). Because the high priority backoff procedure is performed, the AP 110 has a high probability to win channel access.

In the embodiment of FIG. 4A, the latency sensitive traffic is transmitted from the AP 110 to the STA 120. As shown in FIG. 4A, after receiving the RTS frame from the STA 120, the AP 110 does not respond the CTS frame to the STA 120. The AP 110 executes the high priority backoff procedure to access a channel. The AP 110 may transmit the latency sensitive traffic on the channel before the transmission time boundary.

In the embodiment of FIG. 4B, the latency sensitive traffic is transmitted from the AP 110 to the other STA (e.g., the STA 130). As shown in FIG. 4B, the station 120 sends the RTS frame to the AP 110 and the station 130. Before transmission time boundary, the AP 110 does not respond with the CTS frame. The AP 110 executes the high priority backoff procedure to access a channel and transmits the latency sensitive traffic to the STA 130. It should be noted that in the embodiment of FIG. 4B, the STA 130 receives the RTS frame carrying a duration information from the STA 120. The duration information indicates a duration period during which STA120 wants to occupy a channel. After the STA 130 receives the RTS frame, the STA 130 sets a NAVtimeout value and a NAV timer begins counting down. The STA 130 cannot try to access the channel before the NAVtimeout value expires. The AP 110 does not transmit an RTS frame as an initial frame if the AP 110 wants to transmit the latency sensitive traffic to the STA 130. If the AP 110 transmits the RTS frame to the STA 130 and the NAVtimeout value of the STA 130 has not expired, the STA 130 does not respond with a CTS frame to the AP 110. Under this situation, the AP 110 will not transmit the latency-sensitive traffic because the CTS frame is not received by the AP 110. To prevent the above situation, the AP 100 directly transmits the latency-sensitive traffic without transmitting the RTS frame.

After the STA 130 sets a NAVtimeout value, when the NAVtimeout value is expired, the STA 130 detects whether the STA 120 is performing a transmission on the channel. If the STA 120 is not performing the transmission on the channel, the STA 130 will stop the duration period indicated by the duration information in the RTS frame and perform a backoff procedure for contending to access the channel. Because the AP 110 performs the high priority backoff procedure before the NAVtimeout value is expired, the AP 110 can contend the channel before the STA 130 contends the channel. So, the AP 110 has a high probability to win channel access.

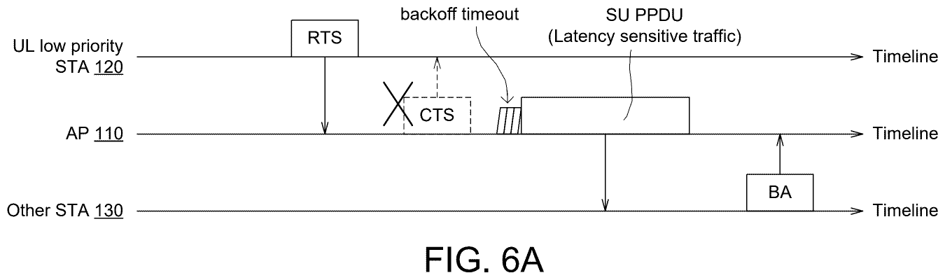

FIG. 5 shows that the AP 110 transmits latency-sensitive traffic directly after receiving RTS frame and waiting for SIFS time, and/or PIFS time, and/or AIFS time according to one embodiment of the application. In this scenario, a backoff procedure is not performed. The AP 110 has a high probability to win channel access.

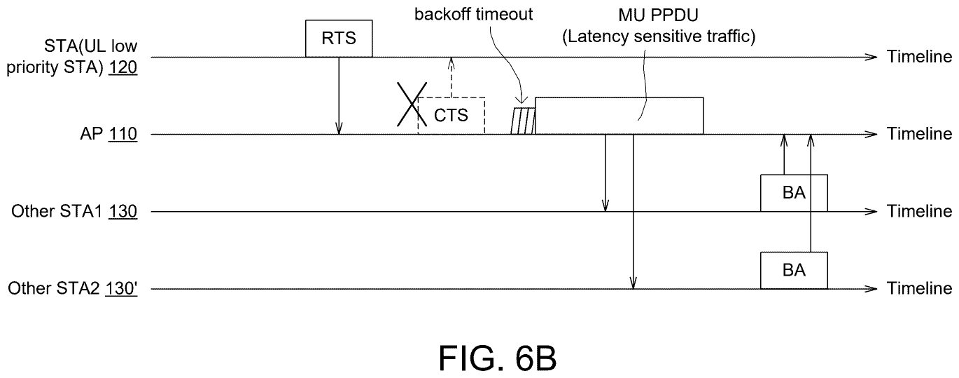

FIG. 6A to FIG. 6C show several examples of the wireless communication according to one embodiment of the application.

In FIG. 6A, the STA 120 sends the RTS frame to the AP 110, wherein the STA 120 has a low priority of UL traffic. When the AP 110 decides not to respond to the STA 120, after the backoff procedure (which means the AP 110 win channel access), the AP 110 transmits a high priority SU (single user) PPDU (Physical Layer Protocol Data Unit) frame to another STA 130 before the transmission time boundary. After receiving the SU PPDU frame from the AP 110, the STA 130 sends a BA (block acknowledgement) frame to the AP 110.

In FIG. 6B, the STA 120 sends the RTS frame to the AP 110, wherein the STA 120 has a low priority of UL traffic. When the AP 110 decides not to respond to the STA 120, after the backoff procedure (which means that the AP 110 win channel access), the AP 110 transmits a high priority MU (multi-user) PPDU frame to the STAs 130 and 130′ before the transmission time boundary. After receiving the MU PPDU frame from the AP 110, the STAs 130 and 130′ send BA frame to the AP 110.

In this scenario, the DL latency sensitive traffic comprises one or more MU PPDU frame. The MU PPDU frame is transmitted to the STAs 130 and 130′. The MU PPDU frame carries traffic to the STA 130 and traffic to the STA 130′. Based on equation 1A or 1B, the AP 110 calculates a transmission time boundary for each of the STAs 130 and 130′. If the duration period indicated by the duration information contained in the RTS frame from the STA 120 to the AP 110 exceeds the transmission time boundary of any STA, the AP 110 decides not to respond to the STA 120.

In FIG. 6C, the STA 120 sends the RTS frame to the AP 110, wherein the STA 120 has a low priority of UL traffic. When the AP 110 decides not to respond to the STA 120, the AP 110 transmits a high priority SU PPDU to the same STA 120 before the transmission time boundary. After receiving PPDU frames from the AP 110, the STA 120 sends BA frame to the AP 110.

The above embodiments describe DL latency sensitive traffic. The solution of the present invention is also applicable to UL latency sensitive traffic. Please refer to the description of the following embodiments for details.

The AP 110 may set a transmission time boundary for a trigger frame for triggering target STA(s) to transmit UL latency sensitive traffic. The UL latency sensitive traffic is high priority traffic.

The STA 120 transmits a RTS (request to send) frame (i.e. a traffic transmission request frame) to the AP 110, wherein the RTS frame includes a duration information indicating a duration period during which the STA 120 expects to occupy a channel. If the AP 110 determines that (1) the duration period indicated by the duration information contained in the RTS frame from the STA 120 to the AP 110 exceeds the transmission time boundary for the trigger frame and (2) a UL traffic priority of STA 120 is low priority based on prediction, the AP 110 decides not to respond the CTS frame to the STA 120.

The AP 110 transmits the trigger frame on the channel to the target STA(s) before the transmission time boundary, so that the target STA(s) transmit UL latency sensitive traffic to the AP 110.

The transmission time boundary setting scenario relies on user-defined requirements or uses information reported by STA(s) to the AP. The user-defined requirements or information reported by the STA(s) to the AP are the same as the corresponding part described above and will not be repeated here.

For predictable UL traffic, the AP 110 determines the transmission time boundary for the trigger frame based on a predictable traffic start time on the STA which receives the trigger, a delay bound, a transmission time of the UL latency sensitive traffic, a buffer time of the UL latency sensitive traffic, a transmission time of the trigger frame, and at least one space time, wherein the transmission time of the UL latency sensitive traffic depends on a traffic size and a transmission rate of the UL latency sensitive traffic, and the buffer time is a value set based on air condition. When the air condition is very congested and collisions are likely to occur easily, a larger buffer time needs to be set. The predictable traffic start time is calculated based on the start time of the latency sensitive traffic service and the interval for transmitting the latency sensitive traffic. For example, but not limited by, for predictable UL traffic, the AP 110 determines the transmission time boundary for the trigger frame by the following equation (1C).

Transmission time boundary =predictable traffic start time+delay bound-(transmission time+buffer time)−at least one space time (1C)

Where the transmission time equals to a sum of a transmission time of the UL latency sensitive traffic and a transmission time of the trigger frame. The trigger frame may comprise the transmission rate of UL latency sensitive traffic. The delay bound indicates a time interval between the predictable traffic start time and the time when the predictable traffic is received.

The schemes shown in FIG. 3, FIG. 4 and FIG. 5 can be applied to transmit the trigger frame. For the sake of brevity, details will not be repeated.

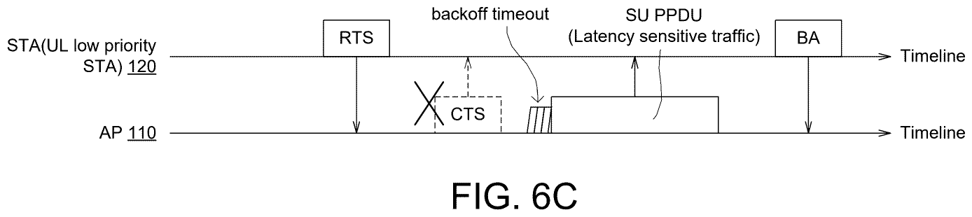

In FIG. 7, the STA 120 sends the RTS frame to the AP 110, wherein the STA 120 has a low priority of UL traffic. When the AP 110 decides not to respond to the STA 120, after the backoff procedure (which means that the AP 110 win channel access), the AP 110 transmits a trigger frame to the STAs 130 and 130′ before the transmission time boundary for the trigger frame to solicit a TB (trigger based)-PPDU for the latency sensitive traffic, wherein the latency sensitive traffic is a high priority UL traffic. After receiving TB-PPDU frames from the STAs 130 and 130′, the AP 110 sends a multi-station BA “M-STA BA” frame to the STAs 130 and 130′. The trigger frame may include the transmission rate for the STAs 130 and 130′ so that the STAs 130 and 130′ can use the transmission rate to transmit the TB-PPDU.

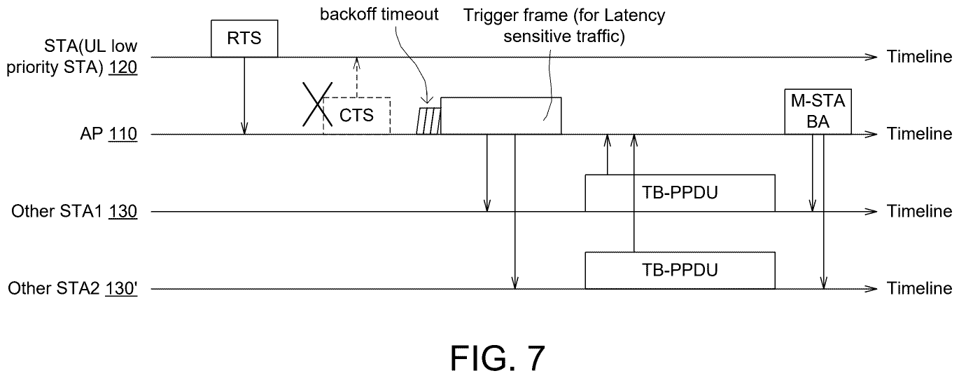

FIG. 8 shows a flow chart for a wireless communication method according to one embodiment of the application.

As shown in FIG. 8, in step 810, a first wireless communication device may determine a transmission time boundary for a transmission, wherein the transmission is a transmission of latency sensitive traffic or a trigger frame.

In step 820, the first wireless communication device may receive a traffic transmission request frame from a second wireless communication device, wherein the traffic transmission request frame comprises a duration information indicating a duration period during which the second wireless communication device expects to occupy a channel.

In step 830, in response that the first wireless communication device determines that the duration period exceeds the transmission time boundary and traffic from the second wireless communication device to the first wireless communication device is latency non-sensitive, the first wireless communication device may decide not to send a traffic transmission permission frame to the second wireless communication device.

In step 840, the first wireless communication device may start the transmission on the channel before the transmission time boundary.

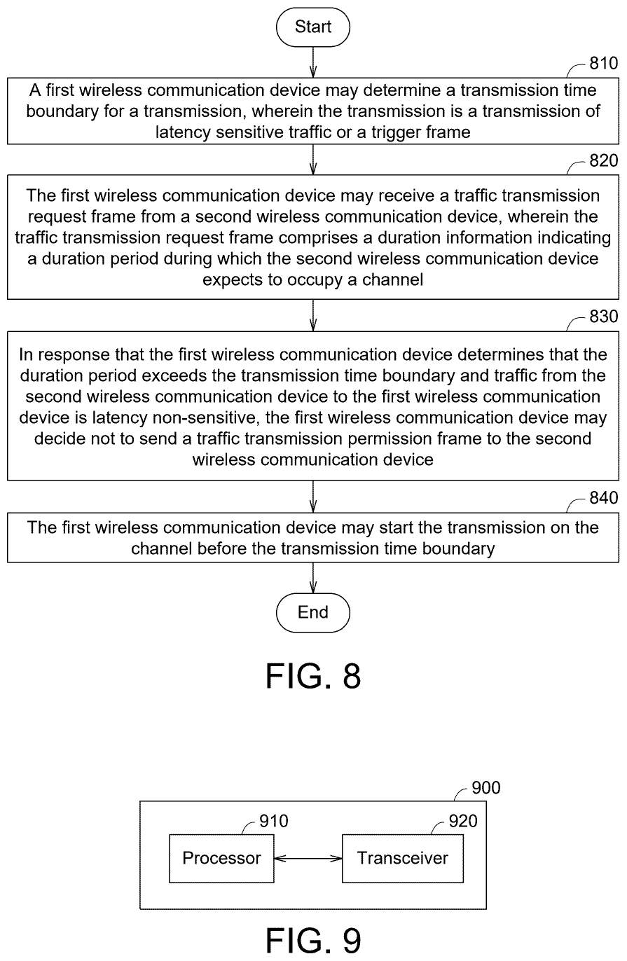

FIG. 9 shows a functional block diagram of a wireless communication device according to one embodiment of the application. The wireless communication device 900 according to one embodiment of the application at least includes a processor 910 and a transceiver 920 coupled to the processor 910. The processor 910 is configured for implementing the wireless communication method in the above example. Specifically, the processor is configured for: determining a transmission time boundary for a transmission, wherein the transmission is a transmission of latency sensitive traffic or a trigger frame; receiving a traffic transmission request frame from a first wireless communication device (for example the station 120), wherein the traffic transmission request frame includes duration information indicating a duration period during which the second wireless communication device expects to occupy a channel; in response that the processor determines that the duration period exceeds the transmission time boundary and traffic from the first wireless communication device is latency non-sensitive, deciding by the processor not to send a traffic transmission permission frame to the first wireless communication device; and starting the transmission before the transmission time boundary.

In one example, wherein the transmission is a transmission of latency sensitive traffic, and based on a user-specified requirement, the processor determines the transmission time boundary, wherein the user-specified requirement comprises at least one of a delay bound of the latency sensitive traffic, a start time of a latency sensitive traffic service and an interval for transmitting the latency sensitive traffic.

In one example, wherein the transmission is a transmission of latency sensitive traffic, and the processor determines the transmission time boundary based on QoS (Quality of Service) characteristics element reported by a wireless communication device which needs to receive the latency sensitive traffic, wherein the QoS characteristics element comprises at least one of the following: a delay bound of the latency sensitive traffic, a start time of a latency sensitive traffic service and an interval for transmitting the latency sensitive traffic.

In one example, wherein the transmission is a transmission of latency sensitive traffic, for predictable latency sensitive traffic, the processor determines the transmission time boundary based on a predictable traffic arrival time on the first wireless communication device, a delay bound, a transmission time and a buffer time of the latency sensitive traffic; and for non-predictable latency sensitive traffic, the processor determines the transmission time boundary based on an actual traffic arrival time on the first wireless communication device, the delay bound, the transmission time and the buffer time of the latency sensitive traffic, wherein the transmission time depends on a traffic size and a transmission rate of the latency sensitive traffic, and the buffer time depends on air condition.

In one example, wherein the transmission is a transmission of a trigger frame, and based on a user-specified requirement, the processor determines the transmission time boundary, wherein the user-specified requirement comprises at least one of a delay bound of latency sensitive traffic, a start time of a latency sensitive traffic service and an interval for transmitting the latency sensitive traffic, and the latency sensitive traffic is triggered by the trigger frame.

In one example, wherein the transmission is a transmission of a trigger frame, and the processor determines the transmission time boundary based on QoS (Quality of Service) characteristics element reported by a wireless communication device which needs to receive the trigger frame, wherein the QoS characteristics element comprises at least one of the following: a delay bound of latency sensitive traffic, a start time of a latency sensitive traffic service and an interval for transmitting the latency sensitive traffic, and the latency sensitive traffic is triggered by the trigger frame.

In one example, wherein the transmission is a transmission of a trigger frame, for predictable latency sensitive traffic, the processor determines the transmission time boundary based on a predictable latency sensitive traffic start time on a wireless communication device which receives the trigger frame, a delay bound, a transmission time and a buffer time of the latency sensitive traffic, a transmission time of the trigger frame, and at least one space time, wherein the transmission time of the trigger frame depends on a size and a transmission rate of the trigger frame, the transmission time of the latency sensitive traffic depends on a traffic size and a transmission rate of the latency sensitive traffic, and the buffer time depends on air condition.

In one example, wherein when recent traffic in a plurality of predetermined periods from the second wireless communication device to the wireless communication device is latency non-sensitive traffic, the processor decides that traffic from the second wireless communication device to the first wireless communication device is latency non-sensitive.

In one example, wherein the transmission is a transmission of the latency sensitive traffic or a trigger frame; if the processor wants to transmit the latency sensitive traffic or a trigger frame to at least one third wireless communication device whose a Network Allocation Vector timeout period is not expired, the processor does not transmit another traffic transmission request frame as an initial frame; and the processor transmits the latency-sensitive traffic or the trigger frame to the at least one third wireless communication device after receiving the traffic transmission request frame and waiting for at least one space time.

In one example, the processor performs a backoff procedure to obtain a right to access the channel after the reception of the traffic transmission request frame is completed; and starts the transmission on the channel.

In one example, wherein the transmission is a transmission of the latency sensitive traffic or a trigger frame, the processor device directly transmits the latency-sensitive traffic or the trigger frame on the channel after receiving the traffic transmission request frame and waiting for at least one space time without performing a backoff procedure.

The above primarily describes the solutions provided in the embodiments of the present application from the perspective of wireless communication. It is understood that to achieve the above functions, the wireless communication device includes corresponding hardware structures and/or software modules that execute functions. Professionals in the technical field can easily recognize that the units and algorithm steps described in the embodiments of the present application can be implemented in hardware form or a combination of hardware and computer software. Whether the functions are performed by hardware or by hardware driven by computer software depends on the specific application and design constraints of the technical solution. Professionals in the technical field can use different methods to implement the functions described in each specific application without departing from the scope of the present application.

In one embodiment of the present application, the wireless communication device can be divided into functional modules based on the aforementioned method examples. For instance, each functional module can be obtained by dividing according to each corresponding function, or two or more functions can be integrated into one processing module. The integrated module can be implemented in hardware form or as a software functional module. It should be noted that in the embodiments of the present application, the division into modules is merely an example and is a logical function division. In the actual implementation process, other division methods can be used.

In summary, although the present invention has been disclosed above with embodiments, it is not intended to limit the present invention. Those skilled in the art to which this invention pertains can make various changes and refinements without departing from the spirit and scope of the invention. Therefore, the scope of protection of the present invention should be defined by the appended claims.

What is claimed is:

1. A wireless communication method, comprising:
determining a transmission time boundary for a transmission by a first wireless communication device;
receiving a traffic transmission request frame by the first wireless communication device from a second wireless communication device, wherein the traffic transmission request frame comprises duration information indicating a duration period during which the second wireless communication device expects to occupy a channel;
in response that the first wireless communication device determines that the duration period exceeds the transmission time boundary and traffic from the second wireless communication device to the first wireless communication device is latency non-sensitive, deciding by the first wireless communication device not to send a traffic transmission permission frame to the second wireless communication device; and
starting the transmission on the channel by the first wireless communication device before the transmission time boundary.

2. The wireless communication method according to claim 1, wherein the transmission is a transmission of latency sensitive traffic, and based on a user-specified requirement, the first wireless communication device determines the transmission time boundary, wherein the user-specified requirement comprises at least one of a delay bound of the latency sensitive traffic, a start time of a latency sensitive traffic service and an interval for transmitting the latency sensitive traffic.

3. The wireless communication method according to claim 1, wherein the transmission is a transmission of latency sensitive traffic, and the first wireless communication device determines the transmission time boundary based on QoS (Quality of Service) characteristics element reported by a wireless communication device which needs to receive the latency sensitive traffic, wherein the QoS characteristics element comprises at least one of the following: a delay bound of the latency sensitive traffic, a start time of a latency sensitive traffic service and an interval for transmitting the latency sensitive traffic.

4. The wireless communication method according to claim 1, wherein the transmission is a transmission of latency sensitive traffic,
for predictable latency sensitive traffic, the first wireless communication device determines the transmission time boundary based on a predictable traffic arrival time on the first wireless communication device, a delay bound, a transmission time and a buffer time of the latency sensitive traffic; and
for non-predictable latency sensitive traffic, the first wireless communication device determines the transmission time boundary based on an actual traffic arrival time on the first wireless communication device, the delay bound, the transmission time and the buffer time of the latency sensitive traffic,
wherein the transmission time depends on a traffic size and a transmission rate of the latency sensitive traffic, and the buffer time depends on air condition.

5. The wireless communication method according to claim 1, wherein the transmission is a transmission of a trigger frame, and based on a user-specified requirement, the first wireless communication device determines the transmission time boundary, wherein the user-specified requirement comprises at least one of a delay bound of latency sensitive traffic, a start time of a latency sensitive traffic service and an interval for transmitting the latency sensitive traffic, and the latency sensitive traffic is triggered by the trigger frame.

6. The wireless communication method according to claim 1,
wherein the transmission is a transmission of a trigger frame, and the first wireless communication device determines the transmission time boundary based on QoS (Quality of Service) characteristics element reported by a wireless communication device which needs to receive the trigger frame,
wherein the QoS characteristics element comprises at least one of the following: a delay bound of latency sensitive traffic, a start time of a latency sensitive traffic service and an interval for transmitting the latency sensitive traffic, and the latency sensitive traffic is triggered by the trigger frame.

7. The wireless communication method according to claim 1, wherein the transmission is a transmission of a trigger frame,
for predictable latency sensitive traffic, the first wireless communication device determines the transmission time boundary based on a predictable latency sensitive traffic start time on a wireless communication device which receives the trigger frame, a delay bound, a transmission time and a buffer time of the latency sensitive traffic, a transmission time of the trigger frame, and at least one space time,
wherein the transmission time of the trigger frame depends on a size and a transmission rate of the trigger frame, the transmission time of the latency sensitive traffic depends on a traffic size and a transmission rate of the latency sensitive traffic, and the buffer time depends on air condition.

8. The wireless communication method according to claim 1, wherein in response that recent traffic in a plurality of predetermined periods from the second wireless communication device to the first wireless communication device is latency non-sensitive traffic, the first wireless communication device decides that traffic from the second wireless communication device to the first wireless communication device is latency non-sensitive.

9. The wireless communication method according to claim 1, wherein the transmission is a transmission of the latency sensitive traffic or a trigger frame;
in response that the first wireless communication device wants to transmit the latency sensitive traffic or a trigger frame to at least one third wireless communication device whose a Network Allocation Vector timeout is not expired, the first wireless communication device does not transmit another traffic transmission request frame as an initial frame; and
the first wireless communication device transmits the latency-sensitive traffic or the trigger frame to the at least one third wireless communication device after receiving the traffic transmission request frame and waiting for at least one space time.

10. The wireless communication method according to claim 1, further comprising:
the first wireless communication device performs a backoff procedure to obtain a right to access the channel after the reception of the traffic transmission request frame is completed.

11. The wireless communication method according to claim 1, wherein the transmission is a transmission of the latency sensitive traffic or a trigger frame, the first wireless communication device directly transmits the latency-sensitive traffic or the trigger frame on the channel after receiving the traffic transmission request frame and waiting for at least one space time without performing a backoff procedure.

12. The wireless communication method according to claim 1, wherein the step of starting the transmission comprising:
the first wireless communication device transmits single-user latency sensitive traffic frame to one third wireless communication device before the transmission time boundary; or
the first wireless communication device transmits multi-user latency sensitive traffic frame to at least two third wireless communication devices before the transmission time boundary; or
the first wireless communication device transmits single-user latency sensitive traffic frame to the second wireless communication device before the transmission time boundary.

13. A wireless communication device comprising:
a processor; and
a transceiver, coupled to the processor,
wherein the processor is configured for:
determining a transmission time boundary for a transmission;
receiving a traffic transmission request frame from a second wireless communication device, wherein the traffic transmission request frame comprises duration information indicating a duration period during which the second wireless communication device expects to occupy a channel;
in response to determining that the duration period exceeds the transmission time boundary and traffic from the second wireless communication device to the wireless communication device is latency non-sensitive, deciding not to send a traffic transmission permission frame to the second wireless communication device; and
starting the transmission on the channel before the transmission time boundary.

14. The wireless communication device according to claim 13, wherein
for predictable latency sensitive traffic, the processor is configured for determining the transmission time boundary based on a predictable traffic arrival time on the wireless communication device, a delay bound, a transmission time and a buffer time of the latency sensitive traffic; and
for non-predictable latency sensitive traffic, the processor is configured for determining the transmission time boundary based on an actual traffic arrival time on the wireless communication device, the delay bound, the transmission time and the buffer time of the latency sensitive traffic,
wherein the transmission time depends on a traffic size and a transmission rate of the latency sensitive traffic, and the buffer time depends on air condition.

15. The wireless communication device according to claim 13, wherein, wherein the transmission is a transmission of a trigger frame,
for predictable latency sensitive traffic, the processor is configured for determining the transmission time boundary based on a predictable latency sensitive traffic start time on a wireless communication device which receives the trigger frame, a delay bound, a transmission time and a buffer time of the latency sensitive traffic, a transmission time of the trigger frame, and at least one space time,
wherein the transmission time of the trigger frame depends on a size and a transmission rate of the trigger frame, the transmission time of the latency sensitive traffic depends on a traffic size and a transmission rate of the latency sensitive traffic, and the buffer time depends on air condition.

16. The wireless communication device according to claim 13, wherein
in response that a recent traffic in a plurality of predetermined periods from the second wireless communication device to the wireless communication device is latency non-sensitive traffic, the processor is configured for deciding that traffic from the second wireless communication device to the wireless communication device is latency non-sensitive.

17. The wireless communication device according to claim 13, wherein the transmission is a transmission of the latency sensitive traffic or a trigger frame,
in response that the wireless communication device wants to transmit the latency sensitive traffic or a trigger frame to at least one third wireless communication device whose a Network Allocation Vector timeout is not expired, the processor does not transmit another traffic transmission request frame as an initial frame; and
the processor is configured for transmitting the latency-sensitive traffic or the trigger frame to the at least one third wireless communication device after receiving the traffic transmission request frame and waiting for at least one space time.

18. The wireless communication device according to claim 13, wherein
the processor is configured for performing a backoff procedure to obtain a right to access the channel after the reception of the traffic transmission request frame is completed and starting the transmission on the channel.

19. The wireless communication device according to claim 13, wherein the transmission is a transmission of the latency sensitive traffic or a trigger frame, the processor is configured for directly transmitting the latency-sensitive traffic or the trigger frame on the channel after receiving the traffic transmission request frame and waiting for at least one space time without performing a backoff procedure.
